(19) United States
(12) Patent Application Publication
(10) Pub. No.: US 2007/0078740 A1
(43) Pub. Date: Apr. 5, 2007

(54) Master-feeder index investment structure

(75) Inventors: Jeff Landle, New York, NY (US); Alexander Schweickhardt, Vienna (AT)

Correspondence Address: SCHULTE ROTH & ZABEL LLP;ATTN: JOEL E. LUTZKER, 919 THIRD AVENUE, NEW YORK, NY, 10022, US

(73) Assignee: H.A.R.D.T. GROUP Investments AG, Vienna (AU)

(21) Appl. No.: 11/243,561

(22) Filed: Oct. 5, 2005

(51) Int. Cl. G06Q 40/00

(52) U.S. Cl. 705/36 R

(57) ABSTRACT

An investment structure including at least one strategy portfolio and a plurality of index funds. The strategy portfolio purchases, sells or enters into derivative contracts of the plurality of the index funds in accordance with its predetermined strategy.

### BACKGROUND OF THE INVENTION

The invention relates to the field of managing and product structuring of collective investment pools commonly referred to as “hedge funds.”

Many, but not all, hedge fund strategies tend to hedge against downturns in the markets being traded. Hedge funds are flexible in their investment options (i.e., they can use short selling, leverage, and derivatives such as options, futures, etc.).

Hedge funds employ a variety of investment strategies, some of which use leverage and derivatives while others are more conservative and employ little or no leverage. Many hedge fund strategies seek to reduce market risk specifically by shorting equity securities, debt securities or derivatives. Performance of hedge funds employing different strategies, particularly relative value strategies, may not be dependent on the direction of the bond or equity markets—unlike conventional equity or mutual funds (unit trusts), which are generally 100% exposed to market risk.

Most hedge funds are highly specialized, relying on the specific expertise of the manager or management team.

Investing in hedge funds tends to be favored by more sophisticated investors who have lived through, and understand the consequences of, major stock market corrections. Many endowments and pension funds also allocate assets to hedge funds.

The popular misconception is that all hedge funds are volatile—that they all use global macro strategies and place large directional bets on stocks, currencies, bonds, commodities, and gold, while employing a significant amount of leverage. In reality, a relatively small percentage of hedge funds are global macro funds. Many hedge funds use derivatives only for hedging or don't use derivatives at all, and many use little to no leverage.

One investment strategy utilized by some funds is to structure investments mimicking a particular financial index. An index is a statistical indicator providing a weighted value of the securities which constitute it. Indices often serve as barometers for a given market or industry and benchmarks against which financial or economic performance is measured. An index investment product typically tracks a predetermined index by investing in the same securities as comprise the index itself, in the same weighted amounts.

“Fund of funds” is a mechanism commonly utilized for structuring a hedge fund product. A fund of funds mixes and matches hedge funds and other pooled investment vehicles. This blending of different strategies and asset classes aims to provide a more stable long-term investment return than any of the individual funds. Returns, risk, and volatility can be controlled by the mix of underlying strategies and funds. Capital preservation is generally an important consideration of such funds. Volatility depends on the mix and ratio of strategies employed.

### SUMMARY OF THE INVENTION

In accordance with one general aspect of the present invention, an investment structure is provided, including at least one strategy portfolio and at least one index fund mimicking a particular predetermined index. The strategy portfolio invests in the index but, instead of buying shares or interests in an index fund, it buys a “derivative,” a financial instrument, the price of which is directly dependent upon (i.e., “derived from”) the value of said index.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWING

The invention is illustrated by way of example and not limitation and the figure of the accompanying drawing in which like references denote like or corresponding parts, and in which:

FIG. 1 is schematic diagram of the investment structure in accordance with the present invention.

### DETAILED DESCRIPTION OF THE PREFERRED EMBODIMENT AND THE DRAWING

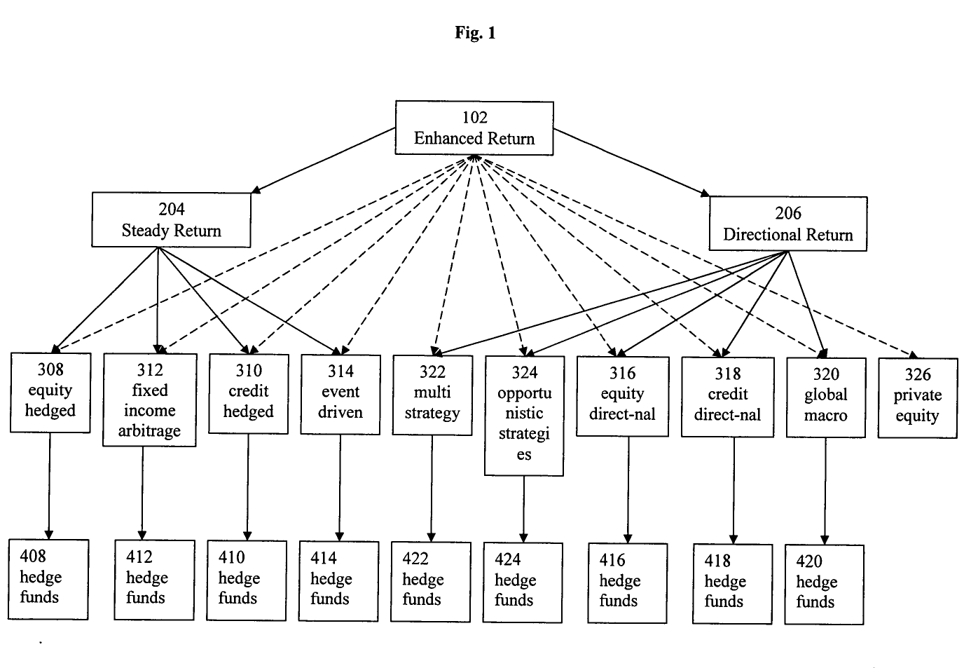

In accordance with the preferred embodiment of the present invention, an investment structure 100 is provided, as shown in FIG. 1. The investment structure 100 includes a strategy portfolio 102 and a plurality of index funds 201-210. Each index fund 201-210 is preferably a passively managed structure that tries to mirror the performance of a specific index, such as HFRX Equity Market Neutral Index, HFRX Aboslute Return Index, Dow Jones Convertible Arbitrage Index, S&P Event Driven Index, etc.

In accordance with the preferred embodiment of the present invention, shown in FIG. 1, rather than purchasing shares or interests in the plurality of index funds 201-210, the strategy portfolio 102 purchases, sells or enters into derivative contracts with the index funds. Thus, in accordance with this preferred embodiment, the strategy portfolio 102 invests in derivative products of index funds 201-210. The decision of which derivative index product to invest in, is preferably made in accordance with the strategy of the strategy portfolio 102.

The investment structure of the present invention allows for tax advantages in addition to its user-transparency.

The preferred embodiments of the invention can be implemented on one or more computer(s) and/or one or more network of computer(s), such as a local area network (LAN), a wide area network (WAN), the Internet and/or another network. In various embodiments, one or more server(s), client computer(s), application computer(s) and/or other computer(s) can be utilized to implement one or more aspect of the invention. Illustrative computers can include, e.g.: a central processing unit; memory (e.g., RAM, etc.); digital data storage (e.g., hard drives, optical disks, flash drives, etc.); input/output ports (e.g., parallel and/or serial ports, etc.); data entry devices (e.g., key boards, etc.); etc. Client computers may contain, in some embodiments, browser software for interacting with the server(s), such as, for example, using hypertext transfer protocol (HTTP) to make requests of the server(s) via the Internet or the like.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

We claim as follows:

1. An investment structure comprising:
at least one strategy portfolio; and
a plurality of index funds,
wherein said at least one strategy portfolio invests in a derivative product of at least one of said plurality of index funds and wherein value of each of derivative product depends on a value of its underlying index.

2. The investment structure according to claim 1, wherein said strategy portfolio has a predetermined investment strategy and wherein said derivative product is selected based on said investment strategy.

3. The investment structure according to claim 1 wherein said underlying index is the HFRX equity market neutral index.

4. The investment structure according to claim 1 wherein said underlying index is the HFRX absolute return index.

5. The investment structure according to claim 1 wherein said underlying index is the Dow Jones convertible arbitrage index.

6. The investment structure according to claim 1 wherein said underlying index is the S&P event driven index.

7. An investment method comprising the steps of:
establishing at least one strategy portfolio;
selecting a plurality of index funds having a value based on an underlying predetermined index; and
causing said at least one strategy portfolio to make at least one derivative investment in any of said selected plurality of index funds.

8. The investment method according to claim 7, wherein said underlying index is the HFRX equity market neutral index.

9. The investment method according to claim 7, wherein said underlying index is the HFRX absolute return index.

10. The investment method according to claim 7, wherein said underlying index is the Dow Jones convertible arbitrage index.

11. The investment method according to claim 7, wherein said underlying index is the S&P event driven index.

12. The investment method according to claim 7, wherein said step of selecting a plurality of index funds is accomplished based on a predetermined investment strategy of said strategy portfolio.
